(19) United States
(12) Patent Application Publication
(10) Pub. No.: US 2026/0267660 A1
(43) Pub. Date: Sep. 10, 2026

(54) Bootstrapping Data Adjustments for Network Device Self-Provisioning

(71) Applicant: Arista Networks, Inc., Santa Clara, CA (US)

(72) Inventors: Eamon James Doyle, Dublin (IE); Mateusz Adam Lewicki, Warsaw (PL); Saurabh Singhal, Bangalore (IN)

(21) Appl. No.: 19/072,235

(22) Filed: Mar. 6, 2025

(51) Int. Cl. G06F 9/4401; H04L 41/0806

(52) U.S. Cl. CPC G06F 9/4416; H04L 41/0806

(57) ABSTRACT

A network device may include processing circuitry configured to obtain bootstrapping data from provisioning equipment. The processing circuitry may make modifications to the obtained bootstrapping data and process the modified bootstrapping data to perform a network device provisioning operation.

### BACKGROUND

This relates to network devices, such as network devices configured to handle bootstrapping data. In particular, a network device may be an initially un-provisioned network device configured to perform a self-provisioning operation by obtaining and processing the bootstrapping data.

### BRIEF DESCRIPTION OF THE DRAWINGS

FIG. 1 is a diagram of an illustrative networking system having a network device communicatively coupled to provisioning equipment in accordance with some embodiments.

FIG. 2 is a diagram of an illustrative network device in accordance with some embodiments.

FIG. 3 is a diagram of illustrative network device processing circuitry configured to make adjustments to received bootstrapping data in accordance with some embodiments.

FIG. 4 is a diagram of an illustrative adjustment to line-endings of bootstrapping data content in accordance with some embodiments.

FIG. 5 is a diagram of an illustrative adjustment to content in a bootstrapping script based on programming language versions in accordance with some embodiments.

FIG. 6 is a diagram of an illustrative adjustment to content encoding schemes of bootstrapping data in accordance with some embodiments.

FIG. 7 is a diagram of an illustrative bootstrapping data file containing file metadata in accordance with some embodiments.

FIG. 8 is a flowchart of illustrative operations for performing bootstrapping data adjustments in accordance with some embodiments.

### DETAILED DESCRIPTION

A network can convey network traffic (e.g., in the form of packets, frames, etc.) between hosts or generally between devices in the network. To properly route and forward the network traffic, the network can include a number of network devices that maintain device configuration data such as forwarding decision data, routing decision data, network policy information, etc. Network devices typically require provisioning and the reception of device configuration data to be operational within the network. To simplify the process of provisioning or configuring a network device for operation, the network device may initiate and perform its own provisioning operation (sometimes referred to as a self-provisioning operation).

As part of the provisioning operation and/or as part of other network device operations, the network device may obtain bootstrapping data (e.g., one or more bootstrapping artifacts each of which may be a bootstrapping script or a device configuration file) and attempt to process the bootstrapping data (e.g., execute the bootstrapping script, store the configuration file and the device configuration data therein, etc.) to successfully complete the provisioning operation.

However, the network device may expect the obtained bootstrapping data to conform to one or more particular forms (e.g., having a specific type of line-endings, having executable scripts based on a specific version of a programming language, use one or more specific encoding schemes or file formats, etc.). Accordingly, bootstrapping data in other forms may be incompatible with the provisioning operation of the network device and may therefore be invalid for installation on the network device. In other words, processing received bootstrapping data that is incompatible or invalid may lead to an unsuccessful provisioning operation or an undesired device configuration.

To mitigate these types of issues and generally perform a more form-tolerant network device provisioning operation and/or to impart other advantages, the network device may identify characteristic(s) of the obtained bootstrapping data causing the bootstrapping data to be invalid for installation or generally incompatible with the provisioning operation. These characteristic(s) may represent issue(s) with the obtained bootstrapping data and may be indicative of incompatible content in the obtained bootstrapping data. Based on the identified characteristics, the network device may adjust (e.g., modify) the bootstrapping data to replace the incompatible content in the obtained bootstrapping data with compatible (replacement) content to correct these issues. The network device may then process the adjusted (e.g., modified) bootstrapping data to successfully complete the provisioning operation. Details for bootstrapping data adjustments (e.g., in the manner described above) are further described herein.

Configurations in which these types of bootstrapping data adjustments (e.g., modifications) are performed on network device processing circuitry are sometimes described herein as an example. If desired, these types of bootstrapping data adjustments may be performed, alternatively or additionally, on provisioning equipment external to the network device, e.g., on processing circuitry of a bootstrap server that provides the bootstrapping data to the network device for the device provisioning operation. In these additional examples, the provisioning equipment may provide the already-adjusted (or already-modified) bootstrapping data to the network device for performing the device self-provisioning operation.

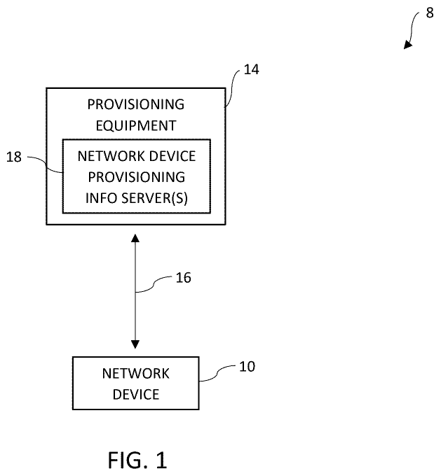

An illustrative networking system in which bootstrapping data adjustments are performed is shown in FIG. 1. In particular, FIG. 1 shows an illustrative network 8 which may be of any suitable scope. As examples, network 8 may include, be, and/or form part of one or more local segments, one or more local subnets, one or more local area networks (LANs), one or more campus area networks, one or more metropolitan area networks, one or more wide area networks, one or more datacenter networks, one or more cloud networks, etc. Network 8 may include any suitable number of different network devices that connect corresponding host devices of network 8 to one another. At least some of these network devices may be connected by one or more wired technologies or standards such as Ethernet (e.g., using electrical cables and/or fiber optic cables), thereby forming a wired network (portion). If desired, network 8 may include a wireless network portion (e.g., one or more wireless local area networks (WLANs)) coupled to the wired network portion. If desired, network 8 may include or be coupled to internet service provider networks (e.g., the Internet) or other public service provider networks, private service provider networks (e.g., multiprotocol label switching (MPLS) networks), and/or other types of networks such as telecommunication service provider networks (e.g., a cellular communication network).

In general, network devices in network 8 can include any number of network switches (e.g., single-layer (Layer 2) switches and/or multi-layer (Layer 2 and Layer 3) switches), bridges, routers, gateways, hubs, repeaters, firewalls, wireless access points, network devices serving other networking functions, network devices that include the functionality of two or more of these devices, management devices that control the operation of one or more of these network devices, and/or other types of network devices.

In the example of FIG. 1, the network devices of network 8 include network device 10 (e.g., one of the types of network devices described above). The networking system of FIG. 1 may also include equipment 14 (e.g., host equipment of network 8). Configurations in which network device 10 is an un-provisioned network device (e.g., not a fully provisioned network device) when initially coupled or connected to other elements of network 8 are sometimes described herein as an illustrative example. Equipment 14, external to device 10, may help facilitate the provisioning of the un-provisioned network device and may be referred to as provisioning equipment 14 in this application.

As one example, equipment 14 may include network device provisioning information server(s) 18 such as a bootstrap server (e.g., a server configured to facilitate zero touch provisioning and/or secure zero touch provisioning, a file server, etc.) that maintains network device provisioning information (e.g., one or more bootstrapping artifacts, sometimes referred to herein generally as bootstrapping data). Device 10 may download the network device provisioning information (e.g., one or more bootstrapping artifacts, bootstrapping data, etc.) from server(s) 18 while performing the self-provisioning operation.

Communication path(s) 16 communicatively coupling network device 10 to equipment 14 (e.g., server(s) 18) may be implemented using network paths of network 8. These network paths may include direct cable connections with or without intervening network devices. In other words, each path 16 may span across portions of network 8 (e.g., one or more network devices therein) to provide the connectivity illustrated in FIG. 1. While shown in FIG. 1 as a single arrow, multiple (different) paths may communicatively couple network device 10 to external equipment 14.

If desired, equipment 14 may include other types of devices or equipment configured to maintain (e.g., store) network device provisioning information (e.g., one or more bootstrapping artifacts, bootstrapping data, etc.), provide the provisioning information to network device 10 during the self-provisioning operation of device 10, and/or otherwise facilitate the self-provisioning operation of device 10. As examples, these other types of devices may include another network device of network 8, a data storage device such as a flash drive, an electronic device such as a laptop, a desktop computer, a cellular telephone, etc. If desired, these other types of devices (e.g., the data storage device) may be directly connected to (e.g., inserted into) network device 10 to provide the communicative coupling.

Network device 10 may also communicate with other equipment in an attempt to perform the provisioning operation that provisions and configures device 10 itself for operation. In particular, network device 10 may communicate with a network address assignment server (e.g., a dynamic host configuration protocol (DHCP) server) to obtain a network address for network device 10. Additionally, the network address assignment server may provide network device 10 with an identifier (e.g., a locator, an address, etc.) for obtaining device provisioning information. As an example, the identifier may identify a given network device provisioning information server 18 (e.g., a bootstrap server, a file server, etc.) and/or may identify a file location on server 18 for obtaining device provisioning information.

After obtaining its network address from the network address assignment server, network device 10 may configure one or more network interfaces using the obtained network address. Using the configured network interface(s), the network device may access the network device provisioning information server 18 to obtain network device provisioning information, such as bootstrapping artifacts or bootstrapping data, stored thereon. As an example, bootstrapping data (or each bootstrapping artifact) may be a (processor-executable) bootstrapping script or another type of executable file, or may be a device configuration file (e.g., network device configuration data for storage). In particular, the bootstrapping script may be a bootstrapping script (e.g., boot file script) for zero touch provisioning, a pre-configuration bootstrapping script for secure zero touch provisioning, a post-configuration bootstrapping script for secure zero touch provisioning, etc. The device configuration file may be for zero touch provisioning or secure zero touch provisioning and may contain device onboarding information for facilitating device networking functions such as a startup configuration, operating system version and/or state information, etc., and/or other bootstrapping data (e.g., certificates and/or other security information, redirect information, etc.).

In general, there may be any number of servers 18 (as described above) provided across various parts of network 8 (e.g., in different network portions of network 8). One or more of these servers 18 may be communicatively coupled to network device 10 and may facilitate the operations described above.

Network device 10 may be considered fully provisioned and ready to perform networking operations (e.g., routing protocols, traffic routing, traffic forwarding, etc.) after successfully executing the obtained executable file(s) (e.g., bootstrapping script(s)), after successfully storing the obtained device configuration data (e.g., the configuration file(s)), after otherwise processing the provisioning information, and/or after rebooting device 10, as examples.

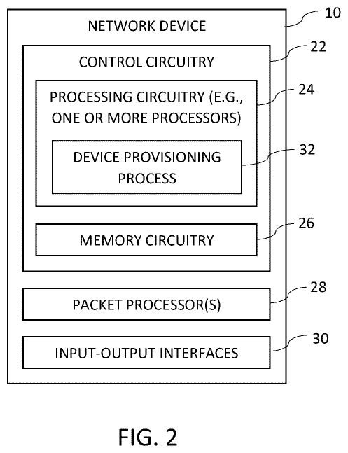

FIG. 2 is a diagram of an illustrative network device such as network device 10 in FIG. 1. In some configurations described herein as an illustrative example, network device 10 may be an un-provisioned network device that automatically initiates a device provisioning operation to provision itself after being introduced to network 8 in FIG. 1 (e.g., after being communicatively coupled to components of network 8 such as a router, a network address assignment server, and/or provisioning equipment 14).

As shown in FIG. 2, network device 10 may include control circuitry 22 having processing circuitry 24 and memory circuitry 26, one or more packet processors 28, and input-output interfaces 30 provided within or on a housing of network device 10. As examples, the housing may include an exterior cover and/or a supporting substrate that provides protection and/or structural support for the components of network device 10 mounted within and/or on the housing. In one illustrative arrangement, network device 10 may be or form part of a modular network device system (e.g., a modular switch system having removably coupled modules usable to flexibly expand characteristics and capabilities of the modular switch system such as to increase the number of ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 24 may include one or more processors such as central processing units (CPUs), graphics processing units (GPUs), microprocessors, general-purpose processors, host processors, coprocessors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 24 may run (e.g., execute) a network device operating system and/or other software (including firmware) that is stored on memory circuitry 26 communicatively coupled to processing circuitry 24. Memory circuitry 26 may include one or more non-transitory (tangible) computer-readable storage media that store the operating system software and/or any other software code, sometimes referred to as program instructions, software instructions, software, data, instructions, or code. As an example, the operations in connection with the processing of (e.g., adjustments to) bootstrapping data and generally the network device self-provisioning process as described herein may be stored as (software) instructions on the one or more non-transitory computer-readable storage media (e.g., in portion(s) of memory circuitry 26). The corresponding processing circuitry (e.g., one or more processors of processing circuitry 24) may process or execute the respective instructions to perform the operations in connection with the processing of (e.g., adjustments to) bootstrapping data and generally the network device self-provisioning process. Accordingly, processing circuitry 24 may be configured to perform these operations described herein.

Memory circuitry 26 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry. Processing circuitry 24 and memory circuitry 26 as described above may sometimes be referred to collectively as control circuitry 22 (e.g., implementing a control plane of network device 10).

As other illustrative operations in addition to operations performed in connection with the processing of (e.g., adjustments to) bootstrapping data (e.g., as part of the device provisioning operation), processing circuitry 24 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 28, may store packet forwarding information, may execute packet processing software, and/or may execute other software instructions that control the functions of network device 10 and the other components therein. Some of these operations such as those associated with routing policy management software, routing protocol agents or processes, routing information base agents, and packet processing software may occur after the device provisioning operation has successfully completed.

Packet processor(s) 28 may be used to implement a data plane or forwarding plane of network device 10. Packet processor(s) 28 may include one or more processors such as application specific integrated circuit (ASIC) processors, programmable logic devices such as field programmable gate array (FPGA) devices, application specific system processors (ASSPs), central processing units (CPUs), graphics processing units (GPUs), microprocessors, general-purpose processors, host processors, coprocessors, microcontrollers, digital signal processors, and/or other types of processors.

Packet processor 28 may receive incoming network traffic via input-output interfaces 30 (and/or other network traffic via internal interfaces), parse and analyze the network traffic, process the network traffic based on packet forwarding decision data (e.g., in a forwarding information base) and/or in accordance with network protocol(s) or other forwarding policy, and forward (or drop) the network traffic accordingly. The packet forwarding decision data may be stored on memory circuitry integrated as part of and/or separate from packet processor 28 (e.g., on content-addressable memory), and/or on a portion of memory circuitry 26. Memory circuitry for packet processor 28 may similarly include volatile memory and/or non-volatile memory.

Input-output interfaces 30 (sometimes referred to herein as network interfaces) may include one or more different types of communication interfaces such as Ethernet interfaces, optical interfaces, network layer (e.g., Internet Protocol (IP) such as IPv4 and/or IPv6) interfaces, wireless interfaces such as WLAN interfaces, and/or other communication interfaces for connecting network device 10 to the Internet, local area network(s), wide area network(s), and/or generally other network device(s), peripheral devices, and computing equipment (e.g., host equipment such as server equipment, client devices, etc.). In illustrative configurations described herein as an example, input-output interfaces 30 may include Ethernet interfaces implemented using and therefore include (Ethernet) ports. In particular, L2 interface circuitry may be coupled to the ports to form Ethernet interfaces with the desired interface configuration. Processing circuitry 24 may further form (e.g., configure) network layer (e.g., IPv4 and/or IPv6) interfaces (e.g., coupled to the L2 interface circuitry) and implemented over the Ethernet interfaces. The network layer interfaces may therefore also form part of network interfaces 30. The ports may be physically coupled and electrically connected to corresponding mating connectors of external equipment, when received at the ports, and may have different form-factors to accommodate different cables, different modules, different devices, or generally different external equipment.

In configurations in which network device 10 is an initially un-provisioned network device, processing circuitry 24 on network device 10 may execute a device provisioning process 32 (sometimes referred to herein as a device provisioning agent or an instance thereof) that helps manage and facilitate (e.g., perform) the device self-provisioning operation described herein after the initially un-provisioned device 10 is supplied with power and is communicatively coupled to component(s) of network 8 (e.g., by having a network connection).

If desired, this provisioning operation may be initiated automatically by executing agent 32 based on one or more criteria being met. The one or more criteria may include a criterion that is met when network device 10 is connected to a power source, a criterion that is met when network device 10 is communicatively coupled to one or more components of network 8, a criterion that is met when network device 10 lacks an initial configuration, a criterion that is met when network device 10 receives one or more user inputs such as the pressing of a button, the providing of a key or other security element, or generally any specified input via a user interface, and/or other suitable provisioning criteria. Configured in this manner, network device 10 may sometimes be referred to as a network device configured for secure zero touch provisioning, zero touch provisioning, one touch provisioning, or minimal touch provisioning.

In one illustrative example, device 10 (e.g., processing circuitry 24 when executing device provisioning process 32) may obtain network configuration information for device 10 such as the network (e.g., IP) address of network device 10 from a network address assignment server. Processing circuitry 24 (e.g., when executing process 32) may use the obtained device network configuration information to form one or more network interfaces 30 (e.g., one or more IPv4 or IPv6 interfaces) for device 10. Processing circuitry 24 (e.g., when executing process 32) may further obtain an indication of network device provisioning information (e.g., identifier(s) of server 18 and/or of provision information stored thereon) from the network address assignment server. Processing circuitry 24 (e.g., when executing process 32) may subsequently communicate with server 18 (e.g., using the one or more IPv4 or IPv6 interfaces) to obtain (e.g., receive, download, etc.) provisioning information, such as executable files (e.g., bootstrapping scripts), device configuration data (e.g., device configuration files), and/or generally other types of bootstrapping data or bootstrapping artifacts. Processing circuitry 24 (e.g., when executing process 32) may process the bootstrapping data (e.g., by executing any bootstrapping scripts, by storing any device configuration files, etc.) to complete the device provisioning operation.

Processing circuitry 24 may execute device provisioning agent 32 by executing software instructions stored on memory circuitry 30 (e.g., one or more non-transitory computer-readable storage media). While device provisioning agent 32 is sometimes described to perform respective parts of the device provisioning operation for provisioning device 10, this is merely illustrative. Processing circuitry 24 may be implemented, organized, and/or configured in any suitable manner (e.g., to execute any other agents or processes instead of or in addition to device provisioning agent 32) to perform each part of the device provisioning operation. Accordingly, processing circuitry 24 may sometimes be described herein to perform the device provisioning operation instead of specifically referring to the one or more agents, processes, and/or kernel executed by processing circuitry 24.

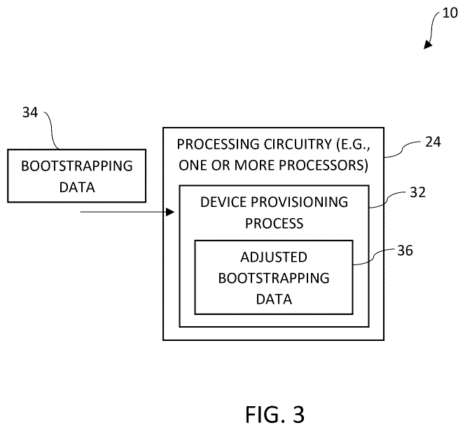

FIG. 3 is a diagram of illustrative network device processing circuitry 24 configured to obtain (e.g., receive, download, etc.) and process bootstrapping data 34 (e.g., one or more bootstrapping artifacts). As one example, bootstrapping data 34 may include a bootstrapping script for zero touch provisioning and/or a (device) configuration file for zero touch provisioning. As another example, bootstrapping data may include a pre-configuration (bootstrapping) script for secure zero touch provisioning, a (device) configuration file for secure zero touch provisioning, and/or a post-configuration (bootstrapping) script for secure zero touch provisioning. If desired other types of illustrative types of bootstrapping artifacts may be used. In configurations sometimes described herein as an example, bootstrapping data 34 may be obtained (e.g., received, downloaded, etc.) from server(s) 18 (FIG. 1) via communication path(s) 16. In other illustrative configurations, bootstrapping data 34 may be obtained (e.g., received) from other types of provisioning equipment 14 (FIG. 1).

However, the form of the received bootstrapping data 34 may not be the expected form(s) of bootstrapping data to be executed and/or stored by processing circuitry 24 as part of the device provisioning operation (e.g., when executing process 32). In other words, the received bootstrapping data 34 may not be valid bootstrapping data for or generally may be incompatible with the device provisioning operation performed by processing circuitry 24. Accordingly, the installation (e.g., execution and/or storage) of the received bootstrapping data 34 in the undesired form may cause the device provisioning operation to fail or lead to undesired device operation after device provisioning.

To mitigate these issues, processing circuitry 24, when performing the device provisioning operation (e.g., when executing process 32), may make appropriate adjustments (e.g., modifications) to the form (e.g., syntax, format, etc.) of the received bootstrapping data 34 prior to installation (e.g., execution and/or storage) by processing circuitry 24. In particular, as shown in the example of FIG. 3, processing circuitry 24, as part of the device provisioning operation, may generate, based on these adjustments, an adjusted (e.g., modified) version of the received bootstrapping data, i.e., adjusted bootstrapping data 36. Adjusted bootstrapping data 36 may be in a form (e.g., syntax, format, etc.) that is expected for (e.g., valid for, compatible with, etc.) the device provisioning operation performed by processing circuitry 24 (e.g., when executing process 32). Therefore, the processing of adjusted (e.g., modified) bootstrapping data 36, instead of the originally obtained bootstrapping data 34, may better facilitate completion of the device provisioning operation.

In general, various types of adjustments (e.g., modifications) may be made. To determine which adjustments are to be made, processing circuitry 24 (e.g., as part of the device provisioning operation) may identify one or more (incompatible) characteristics of the received bootstrapping data 34 (e.g., issues to be corrected). Processing circuitry 24 may adjust the received bootstrapping data 34 using a type of adjustment corresponding to a respective characteristic, thereby correcting the received bootstrapping data 34 prior to installation (e.g., execution and/or storage). In illustrative configurations described herein as example, these adjustments may include replacing incompatible bootstrapping data content indicated by a characteristic with replacement bootstrapping data content that is compatible with the provisioning operation performed by processing circuitry 24. Because incompatibility may often be caused by syntax, the replacement content may not substantively change the original content (e.g., the meaning, intent, interpretation, etc., of the original content).

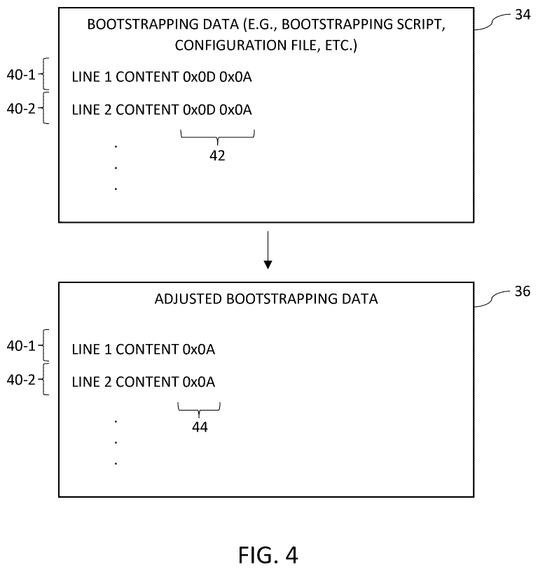

Some illustrative types of adjustments are described in connection with the examples shown in FIGS. 4-6. These adjustments are merely illustrative. If desired, other types of adjustments to received bootstrapping data 34 may be performed by processing circuitry 24 (e.g., as part of the provisioning operation, when executing process 32) to generate adjusted bootstrapping data 36.

As shown in the example of FIG. 4, the originally obtained bootstrapping data 34 (e.g., bootstrapping script(s) and/or device configuration file(s) received or downloaded from server 18 in FIG. 1) may include content in lines 40. For example, line 1 content may be in line 40-1, line 2 content may be in line 40-2, etc. Endings of each line 40 may be denoted by a corresponding line-ending. In particular, bootstrapping data 34 may include a first type of line-ending 42 denoting the end of each line 40. Line-endings 42 may each contain a carriage-return character (0x0D) and a line-feed character (0x0A).

Processing circuitry 24 (FIG. 3) may identify the first type of line-ending (e.g., the first type of line-ending 42) as an incompatible characteristic of bootstrapping data 34 (e.g., as an issue to be corrected). For example, processing circuitry 24, when performing the device provisioning operation, may be unable to properly parse line-endings 42 and may be unable to properly process bootstrapping data with line-endings 42. Accordingly, based on the identified incompatible characteristic, processing circuity 24 may adjust (e.g., modify) bootstrapping data 34 by replacing (e.g., converting) each instance of incompatible content (e.g., the line-ending 42 of each line 40 indicated by the identified characteristic) with corresponding compatible replacement content (e.g., a second type of line-ending for each line 40) which can be properly parsed and processed by processing circuitry 24. As one example, the compatible replacement content may be (replacement) type of line-ending 44 containing the line-feed character (0x0A) without the carriage-return character (0x0D).

In the example of FIG. 4, the adjustment to bootstrapping data involves, for each line 40, replacing a carriage-return character and a line-feed character with the line-feed character without the carriage-return character (e.g., removing the carriage-return character). If desired, other types of line-ending replacements may be performed by processing circuitry 24. As examples, line-endings 42 may be replaced with another type of line-ending (different from the type of line-ending 44), another type of line-ending in originally obtained bootstrapping data 34 may be replaced with line-endings 44, etc.

The adjusted (e.g., modified) bootstrapping data 36 containing the compatible type of line-ending for each line 40 may be correct and valid for further processing (e.g., installation) of the bootstrapping data by processing circuitry 24 (e.g., execution of any scripts in the bootstrapping data, storage of any configuration files in the bootstrapping data, etc., to complete the provisioning operation). In such a manner, an identified issue (e.g., incompatible characteristic) associated with line-endings in the originally obtained bootstrapping data may be corrected prior to installing (e.g., executing and/or storing) the bootstrapping data.

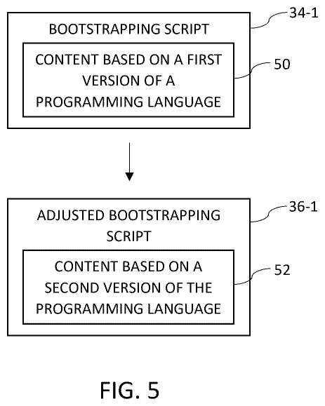

As shown in the example of FIG. 5, the originally obtained bootstrapping data 34 (FIG. 3) may be or include a bootstrapping script 34-1 (e.g., received or downloaded from server 18 in FIG. 1). Bootstrapping script 34-1 may contain content 50 based on (e.g., written in) a first version of a programming language, such as version 2 of the Python programming language (sometimes referred to as Python 2).

Processing circuitry 24 (FIG. 3) may identify the use of the first version of the programming language (e.g., Python 2) as the incompatible characteristic of bootstrapping script 34-1 (e.g., as an issue to be corrected). For example, processing circuitry 24, when performing the device provisioning operation, may be unable to properly parse content 50 for execution (e.g., processing circuitry 24 may be configured to execute scripts based on a different version of the programming language). Accordingly, based on the identified incompatible characteristic, processing circuitry 24 may adjust (e.g., modify) bootstrapping script 34-1 by replacing (e.g., converting) incompatible portion(s) of content 50 (e.g., indicated by the identified characteristic) with corresponding compatible replacement content (e.g., based on a compatible programming language, based on a compatible version of a programming language, etc.) which can be properly parsed and executed by processing circuitry 24. As one example, the compatible replacement content may be replacement content 52 based on (e.g., written in) a second (compatible) version of the programming language such as version 3 of the Python programming language (sometimes referred to as Python 3).

In the example of FIG. 5, the adjustment to a bootstrapping script involves converting content between different versions of a programming language. If desired, other types of programming language conversions (e.g., conversion between different versions of Python or another programming language, conversions between different programming languages, etc.) may be performed by processing circuitry 24.

The adjusted (e.g., modified) bootstrapping script 36-1 containing compatible content 52 may be correct and valid for further processing (e.g., for installation, for execution, etc.) by processing circuitry 24 to complete the provisioning operation. In such a manner, an identified issue (e.g., incompatible characteristic) associated with a programming language (or generally with programming syntax, semantics, etc.) may be corrected prior to execution of the bootstrapping script.

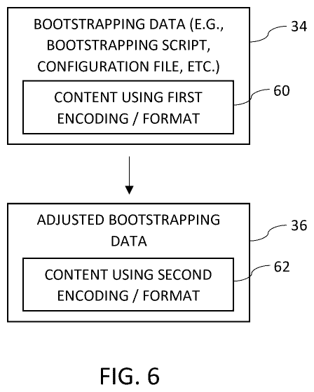

As shown in the example of FIG. 6, the originally obtained bootstrapping data 34 (e.g., bootstrapping script(s) and/or device configuration file(s) received or downloaded from server 18 in FIG. 1) may contain content 60 encoded with first encoding scheme(s) (e.g., for a first file format or a first file type).

Processing circuitry 24 (FIG. 3) may identify the use of the first encoding scheme(s) (e.g., encoding scheme(s) for a JavaScript object notation (JSON) file, an extensible markup language (XML) file, a YANG file, a YAML file, a hypertext markup language (HTML) file, a word processing document file, etc.) as the incompatible characteristic of bootstrapping data 34 (e.g., as an issue to be corrected). For example, processing circuitry 24, when performing the device provisioning operation, may be unable to properly parse content 60 for execution and/or storage (e.g., processing circuitry 24 may be configured to process bootstrapping data content encoded in other manners). Accordingly, based on the identified incompatible characteristic, processing circuitry 24 may adjust (e.g., modify) bootstrapping data 34 by replacing (e.g., converting) incompatible portion(s) of content 60 (e.g., as indicated by the identified characteristic) with corresponding compatible replacement content (e.g., based on compatible encoding scheme(s) for compatible file types or formats) which can be properly parsed and processed by processing circuitry 24. As one example, the compatible replacement content may be replacement content 62 encoded with second encoding scheme(s) (e.g., for a second file format or a second file type), such as encoding scheme(s) for a command line interface (CLI) file.

In the example of FIG. 6, the adjustment to bootstrapping data 34 involves converting content between different encoding schemes (e.g., between different file formats or types). If desired, other types of data encoding, file format, and/or file type conversions may be performed.

The adjusted (e.g., modified) bootstrapping data 36 containing compatible content 62 may be correct and valid for further processing (e.g., installation) by processing circuitry 24 (e.g., execution of any scripts in the bootstrapping data, storage of any configuration files in the bootstrapping data, etc., to complete the provisioning operation). In such a manner, an identified issue (e.g., incompatible characteristic) associating with data encoding, file format, and/or file type may be corrected prior to installing (executing and/or storing) the bootstrapping data.

Processing circuitry 24, as part of performing the device provision operation (e.g., when executing process 32), may identify incompatible characteristic(s) such as those described in connection with FIGS. 4-6 in any suitable manner. As one illustrative example, processing circuitry 24 may directly inspect the originally obtained bootstrapping data 34 to identify any incompatible characteristics therein (e.g., identify any corresponding issues with parsing and processing the received bootstrapping data 34).

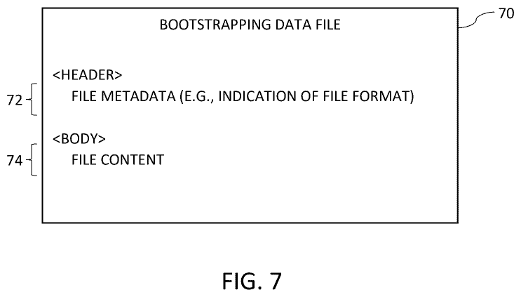

As another illustrative example, bootstrapping data 34 may be obtained along with corresponding metadata for bootstrapping data 34. Processing circuitry 24 may identify any incompatible characteristics (e.g., issues) based on the received metadata. In particular, in the example of FIG. 7, processing circuitry 24 may obtain (e.g., received, download) bootstrapping data 34 (FIG. 3) as part of a bootstrapping data file 70 (e.g., from provisioning equipment 14, such as server 18, in FIG. 1). File 70 may include a header (section) containing header content 72 and may include a body (section) containing file content 74 (e.g., bootstrapping data 34, one or more bootstrapping artifacts, etc.). Header content 72 may contain metadata for file 70, including metadata for file content 74.

Accordingly, processing circuitry 24 may identify any incompatible characteristics of bootstrapping data 34 (e.g., in file content 74) by inspecting the file metadata in header content 72. As one illustrative example, the file metadata may contain indication(s) of the form of the file content (e.g., the encoding, format, version, etc.). Processing circuitry 24 may determine the type(s) of adjustment(s) (e.g., one or more of the adjustments described in connection with FIGS. 4-6) to make to the received bootstrapping data 34 based on indication(s) of the form of file content 74.

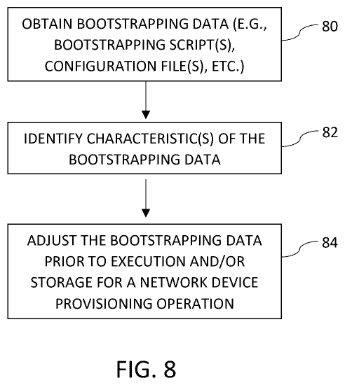

FIG. 8 is a flowchart of illustrative operations for performing bootstrapping data adjustments. These operations may be performed at one or more processors of processing circuitry 24 in network device 10. The illustrative operations described in connection with FIG. 8 may generally be performed by processing circuitry 24 executing software instructions (e.g., for implementing a device provisioning process 32) stored on memory circuitry 26. If desired, one or more operations described in connection with FIG. 8 may be performed by other dedicated hardware components in device 10.

Configurations described in connection with FIGS. 3-7 in which bootstrap data adjustments are performed on network device processing circuitry (e.g., processing circuitry 24) are described herein as one illustrative example. If desired, the operations described in connection with FIGS. 3-7 and performed by processing circuitry 24 may instead or additionally be performed by processing circuitry (e.g., one or more processors of the same type as processing circuitry 24) of provisioning equipment 14 such as server 18 (FIG. 1).

Accordingly, if desired, the operations described in connection with FIG. 8 may be performed at one or more processors of provisioning equipment 14 (e.g., server 18). In particular, the illustrative operations described in connection with FIG. 8 may similarly be performed by the one or more processors of provisioning equipment 14 (e.g., server 18) executing software instructions stored on memory circuitry of provisioning equipment 14 (e.g., of server 18) which may be of the same type as memory circuitry 26. If desired, one or more operations described in connection with FIG. 8 may be performed by other dedicated hardware components of provisioning equipment 14 (e.g., server 18).

At block 80, one or more processors (e.g., processing circuitry 24 of device 10, processing circuitry of server 18 or other provisioning equipment 14) may obtain bootstrapping data (e.g., bootstrapping script(s), network device configuration file(s), etc.). When the operations of block 80 are performed by processing circuitry 24 of device 10, the bootstrapping data may be obtained (e.g., received, downloaded, etc.) from provisioning equipment 14 (e.g., server 18), as described in connection with FIGS. 1-3 and 7. When the operations of block 80 are performed by the processing circuitry of server 18 or other provisioning equipment, the bootstrapping data may be obtained from user input (e.g., as a user-provided bootstrapping data file).

At block 82, the one or more processors may identify characteristic(s) of (e.g., issues with) the obtained bootstrapping data causing incompatibility with bootstrapping data parsing, execution, storage, and/or other types of processing. For example, processing circuitry 24 of device 10 or the processing circuitry of server 18 (or other provisioning equipment 14) may identify the types of characteristics described in connection with FIGS. 3-6 and in the manners described in connection with FIGS. 3 and 7.

At block 84, the one or more processors may adjust (e.g., modify) the bootstrapping data, based on the identified characteristic(s), prior to execution and/or storage (installation) for a network device provisioning operation. For example, processing circuitry 24 of device 10 or the processing circuitry of server 18 (or other provisioning equipment 14) may make the types of adjustments (e.g., modifications) described in connection with FIGS. 3-6.

When the bootstrapping data adjustments are performed by processing circuitry 24 of device 10, the adjusted bootstrapping data may further be locally processed or installed (e.g., by executing adjusted or modified bootstrapping script(s), by storing adjusted or modified network device configuration file(s), etc.) to complete the network device (self-)provisioning operation. When the bootstrapping data adjustments are performed by processing circuitry of server 18 (or other provisioning equipment 14), the adjusted bootstrapping data may further be provided to device 10 (e.g., via communication link(s) 16 in FIG. 1) to be further processed or installed (e.g., by executing adjusted or modified bootstrapping script(s), by storing adjusted or modified network device configuration file(s), etc.) for the network device (self-)provisioning operation of device 10.

The methods and operations described above in connection with FIGS. 1-8 may be performed by the components of one or more network devices and/or server or other provisioning equipment using software (including firmware) and/or hardware (e.g., dedicated circuitry or hardware). Software code for performing these operations may be stored on one or more non-transitory computer-readable storage media (e.g., tangible computer readable storage media) on one or more of the components of the network device(s) and/or server or other provisioning equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device(s) and/or server or other provisioning equipment (e.g., processing circuitry 24 in network device 10, processing circuitry of server 18, processing circuitry of provisioning equipment 14).

The foregoing is merely illustrative and various modifications can be made to the described embodiments. The foregoing embodiments may be implemented individually or in any combination.

What is claimed is:

1. A network device configured to perform self-provisioning, the network device comprising:
memory circuitry; and
processing circuitry coupled to the memory circuitry and configured to:
receive bootstrapping data from external equipment;
identify a characteristic of the received bootstrapping data;
adjust the received bootstrapping data based on the identified characteristic; and
process the adjusted bootstrapping data to perform a device self-provisioning operation.

2. The network device defined in claim 1, wherein the identified characteristic is indicative of content in the received bootstrapping data that is incompatible with the device self-provisioning operation and wherein the received bootstrapping data is adjusted by replacing the content with replacement content that is compatible with the device self-provisioning operation.

3. The network device defined in claim 2, wherein the content comprises a bootstrapping script or a configuration file.

4. The network device defined in claim 3, wherein the bootstrapping script is a bootstrapping script for zero touch provisioning, a pre-configuration script for secure zero touch provisioning, or a post-configuration script for secure zero touch provisioning and wherein the configuration file is a configuration file for zero touch provisioning or a configuration file for secure zero touch provisioning.

5. The network device defined in claim 2, wherein the identified characteristic comprises a first type of line-ending, wherein the content comprises line-endings each of the first type of line-ending, and wherein the replacement content comprises line-endings each of a second type of line-ending.

6. The network device defined in claim 5, wherein the first type of line-ending contains a carriage-return character and a line-feed character and wherein the second type of line-ending contains the line-feed character without the carriage-return character.

7. The network device defined in claim 2, wherein the identified characteristic comprises a first version of a programming language, wherein the content is based on the first version of the programming language, and wherein the replacement content is based on a second version of the programming language.

8. The network device defined in claim 7, wherein the content is a bootstrapping script.

9. The network device defined in claim 2, wherein the identified characteristic comprises a first type of encoding scheme, wherein the content uses the first type of encoding scheme, and wherein the replacement content uses a second type of encoding scheme.

10. The network device defined in claim 1, wherein the processing circuitry is configured to perform an inspection of the received bootstrapping data and wherein the characteristic of the received bootstrapping data is identified based on the inspection of the received bootstrapping data.

11. The network device defined in claim 1, wherein the bootstrapping data is received from the external equipment in a bootstrapping data file, wherein the bootstrapping data file includes a header containing file metadata and includes a body containing the bootstrapping data, and wherein the characteristic of the received bootstrapping data is identified based on the file metadata.

12. The network device defined in claim 1, wherein the external equipment comprises a server that maintains the bootstrapping data.

13. The network device defined in claim 1, wherein the adjusted bootstrapping data comprises an adjusted bootstrapping script and wherein the processing circuitry is configured to process the adjusted bootstrapping data by executing the adjusted bootstrapping script.

14. The network device defined in claim 1, wherein the adjusted bootstrapping data comprises an adjusted configuration file and wherein the processing circuitry is configured to process the adjusted bootstrapping data by storing the adjusted configuration file on the memory circuitry.

15. An un-provisioned network device configured to perform self-provisioning, the un-provisioned network device comprising:
memory circuitry; and
processing circuitry coupled to the memory circuitry and configured to:
perform, based on one or more criteria being met, a device self-provisioning operation by:
downloading one or more bootstrapping artifacts from a server;
identifying an issue with the one or more downloaded bootstrapping artifacts causing the one or more downloaded bootstrapping artifacts to be invalid for installation;
modifying the one or more downloaded bootstrapping artifacts to correct the issue; and
installing the one or more modified bootstrapping artifacts.

16. The un-provisioned network device defined in claim 15, wherein the one or more downloaded bootstrapping artifacts are modified by converting content in the one or more downloaded bootstrapping artifacts between different types of line-endings, by converting content in the one or more downloaded bootstrapping artifacts between different versions of a programming language, or by converting content in the one or more downloaded bootstrapping artifacts between different types of encoding schemes.

17. The un-provisioned network device defined in claim 15, wherein the one or more criteria comprise a criterion that is met when the un-provisioned network device is connected to a power source, a criterion that is met when the un-provisioned network device is communicatively coupled to a network, or a criterion that is met when the un-provisioned network device lacks an initial configuration.

18. One or more non-transitory computer-readable media comprising computer-executable instructions that, when executed by one or more processors, cause the one or more processors to:
obtain one or more bootstrapping artifacts;
identify an issue with the one or more obtained bootstrapping artifacts that causes incompatibility with a network device provisioning operation;
modify the one or more obtained bootstrapping artifacts to correct the issue; and
provide the one or more modified bootstrapping artifacts to a network device as part of the network device provisioning operation.

19. The one or more non-transitory computer-readable media defined in claim 18, wherein the one or more obtained bootstrapping artifacts are modified by converting content in the one or more obtained bootstrapping artifacts between different types of line-endings, by converting content in the one or more obtained bootstrapping artifacts between different versions of a programming language, or by converting content in the one or more obtained bootstrapping artifacts between different types of encoding schemes.

20. The one or more non-transitory computer-readable media defined in claim 18, wherein the one or more modified bootstrapping artifacts provided to the network device comprise a bootstrapping script for zero touch provisioning, a configuration file for zero touch provisioning, a pre-configuration script for secure zero touch provisioning, a configuration file for secure zero touch provisioning, or a post-configuration script for secure zero touch provisioning.
